(19) United States
(12) Patent Application Publication
(10) Pub. No.: US 2010/0226117 A1
(43) Pub. Date: Sep. 9, 2010

(54) TEXTILE PRODUCT AND METHOD OF MANUFACTURING OF SUCH TEXTILE PRODUCT

(75) Inventors: Martijn Krans, Eindhoven (NL); Erich Zainzinger, Hong Kong (CN); Wouter Bastiaan Zeper, Eindhoven (NL); Thomas Schuler, Leuven (BE); Guido Theo Maria Lamerichs, Leuven (BE); Carla Andrea Parilo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,559

(22) PCT Filed: Jun. 4, 2007
(86) PCT No.: PCT/IB2007/052077

§ 371 Date: Dec. 5, 2008

(30) Foreign Application Priority Data
Jun. 8, 2006 (EP) 06115154.4

(51) Int. Cl. G09F 13/00; G02B 5/02; D99Z 99/00

(52) U.S. Cl. 362/97.1; 359/599; 28/100

(57) ABSTRACT

The present invention relates to a textile product (10) comprising an outer fabric (12) and a flexible light-emitting display (14) arranged behind the outer fabric, which flexible display has a diffusing element (20) being arranged to receive and diffuse light emitted from the flexible display. The textile product is characterized by a diffusing spacer fabric (20) arranged adjacent to the outer fabric so as to receive and further diffuse light emitted from the flexible display, which diffusing spacer fabric (22) is separate from the diffusing element (20). The diffusing spacer fabric acts as a second diffusing element, and allows for improved diffusing functionality. The present invention also relates to a method for the manufacturing of such a textile product, and a flexible light-emitting display adapted for use in a textile product.

### TECHNICAL FIELD OF THE INVENTION

The present invention relates to a textile product comprising an outer fabric and a flexible light-emitting display arranged behind the outer fabric, which flexible display has a diffusing element being arranged to receive and diffuse light emitted from the flexible display. The present invention also relates to a method for the manufacturing of such a textile product, and a flexible light-emitting display adapted for use inside a textile product.

### BACKGROUND OF THE INVENTION

An example of such a textile product is disclosed in the document WO2004/100111, wherein a flexible display is incorporated in a garment, such as a shirt. A diffusing element is provided either on the flexible display itself or in the garment, namely in a pocket of the garment accommodating the flexible display, so as to diffuse light coming from two adjacent discrete light sources of the flexible display in order to produce a substantially continuous light display. Thus, a single diffusing element is used.

Another garment, namely a jacket, with a flexible display screen having light-emitting diodes (LEDs) thereon is disclosed in the document WO2006/014230. The flexible display screen is arranged directly behind an outer cloth of the garment, which outer cloth may act as an optical diffuser for the LEDs.

Both these prior art textile products utilize a single diffusing element. This may hamper the diffusing functionality, both in terms of limited overall diffusing effect and limited control of the diffusing effect. Also, the diffusing element disclosed in WO2004/100111 has a considerable thickness, which may cause the display's contours to be visible from the outside of the garment, even if it is turned off.

### SUMMARY OF THE INVENTION

It is an object of the present invention to overcome or at least alleviate these problems, and to provide an improved textile product.

This and other objects that will be evident from the following description are achieved by means of a textile product, a method for the manufacturing of a textile product, and a flexible light-emitting display adapted for use in a textile product, according to the appended claims.

According to an aspect of the invention, there is a provided textile product comprising an outer fabric and a flexible light-emitting display arranged behind the outer fabric, which flexible display has a diffusing element being arranged to receive and diffuse light emitted from the flexible display, the textile product being characterized by a diffusing spacer fabric arranged adjacent to the outer fabric so as to receive and further diffuse light emitted from the flexible display, which diffusing spacer fabric is separate from the diffusing element.

The diffusing spacer fabric acts as a second separate diffusing element, and tuning the characteristics of the two diffusing elements, such as material, thickness, profile structure, shape, density, etc., allows for optimization of the light diffusing characteristics. For instance, two diffusing elements with different densities (similar or different materials) could be used to achieve desired diffusing characteristics. Moreover, two different fabrics like foam and needle padding with similar densities can still show totally different light emitting effects, which again allows for optimization of the diffusing characteristics.

Preferably, the diffusing spacer fabric is arranged between the flexible display and the outer fabric, so that the appearance and outer surface structure of the outer fabric is maintained. Alternatively, the diffusing spacer fabric could be attached outside of the outer fabric.

In one embodiment, the diffusing spacer fabric has a substantially larger area compared to the flexible display. For example, in case the textile product is a jacket, the area of the diffusing spacer fabric preferably matches that of the front or backside of the jacket, or that of any other piece of fabric of the textile product that the flexible display is attached to. The diffusing spacer fabric having the substantially larger area compared to the flexible display substantially prevents the contours of the flexible display from being visible from the outside of the textile product, so that the display is not revealed when it is its off-state.

In one embodiment, the diffusing spacer fabric has a greater thickness than the outer fabric. To this end, the diffusing spacer fabric is adapted to space the flexible display from the outer fabric.

In one embodiment, the textile product further comprises additional spacer fabric arranged around the flexible display. The thickness of the additional spacer fabric preferably matches that of the flexible display, so that the part of the textile product incorporating the flexible display gets a uniform thickness. This is especially advantageous in case the textile product is a garment, since the uniform thickness makes the garment more comfortable to wear for a user. The additional spacer fabric may further reduce the visibility of the contours of the flexible display from the outside of the textile product.

In one embodiment, the flexible display is arranged between the diffusing spacer fabric/outer fabric (depending on which one is farthest in) and an inner fabric. Here the flexible display (or any pocket accommodating the flexible display) can be attached to either the diffusing spacer fabric/outer fabric or the inner fabric, for example. In the latter case, the flexible display is preferably also attached to the diffusing spacer fabric/outer fabric, in order to maintain the distance between the flexible display and the diffusing spacer fabric/outer fabric so that the display performance is not altered and/or degraded.

In one embodiment, the flexible display comprises a flexible substrate having at least one light source mounted thereon, and a flexible thermo regulating layer is provided on the opposite side of the substrate compared to the side with the at least one light source for dissipating heat from the remaining display device. This allows for consistent operation and increased endurance of the display. Further, using a flexible thermo regulating layer allows the display to maintain its overall flexible nature.

In one embodiment, the textile product is a garment, such as a jacket, a vest, a sweater, or a shirt.

According to another aspect of the invention, there is provided a method for the manufacturing of a textile product comprising an outer fabric, the method comprising arranging a flexible light-emitting display behind the outer fabric, which flexible display has a diffusing element being arranged to receive and diffuse light emitted from the flexible display, the method being characterized by arranging a separate diffusing spacer fabric adjacent to the outer fabric so as to receive and further diffuse light emitted from the flexible display. This method offers similar advantages as obtained with the previously discussed aspect of the invention.

According to another aspect of the invention, there is provided a flexible light-emitting display adapted for use behind an outer fabric of a textile product, which flexible display has a diffusing element being arranged to receive and diffuse light emitted from the flexible display, and which textile product further comprises a separate diffusing spacer fabric arranged adjacent to the outer fabric so as to receive and further diffuse light emitted from the flexible display. This aspect offers similar advantages as obtained with the previously discussed aspects of the invention.

### BRIEF DESCRIPTION OF THE DRAWINGS

These and other aspects of the present invention will now be described in more detail; with reference to the appended drawings showing currently preferred embodiments of the invention.

FIG. 1 is a front view of a textile product according to the invention,

FIG. 2 is a cross-sectional partial side view of the textile product in FIG. 1, and

FIGS. 3-7 are cross-sectional partial side views of various embodiments of the textile product according to the invention.

### DETAILED DESCRIPTION OF EMBODIMENTS

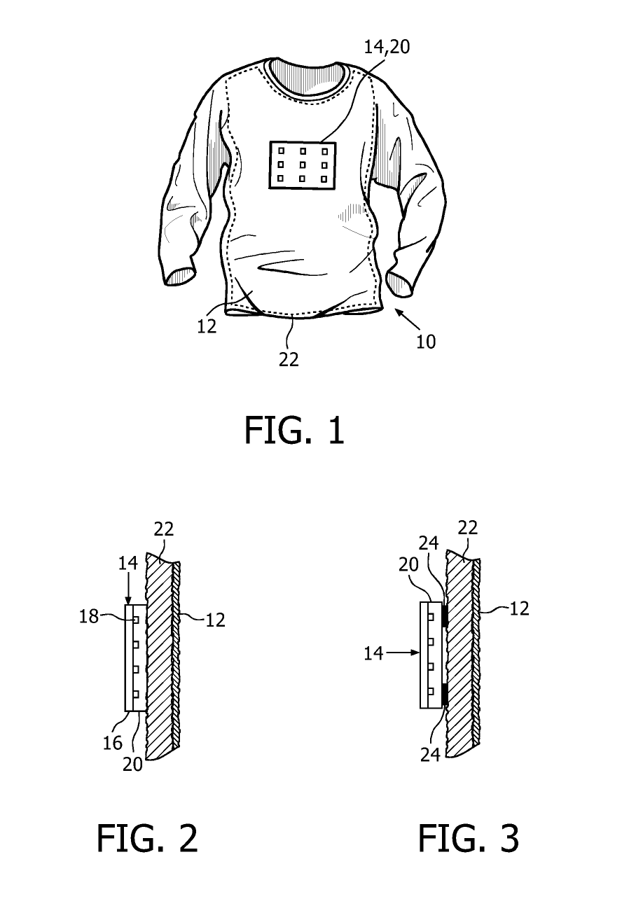

A textile product according to a basic embodiment of the present invention will now be described in relation to FIGS. 1 and 2. The textile product 10, here a shirt, comprises an outer fabric 12, behind which a flexible light-emitting display 14 is arranged. The flexible display 14 comprises a flexible substrate 16, which for example can be made of plastics or fabrics, and a plurality of discrete light sources 18, preferably light emitting diodes (LEDs). LEDs exhibit several advantages, which become handy in this application, for example high durability, low power consumption, high luminance, etc. The flexible display 14 may emit light such that a viewer can see graphical shapes, text based characters, and etc. on the display 14 through the outer fabric 12, and it can for example be of any type described in the above-mentioned documents WO2004/100111 and WO2006/014230.

The flexible display 14 comprises a diffusing element 20 arranged to receive and diffuse light emitted from the flexible display 14, so as to diffuse light coming from two adjacent LEDs 18 in order to produce a substantially continuous light display. An example of such a flexible display with diffusing element is disclosed in the above-mentioned document WO2004/100111.

According to the present invention, the textile product 10 further comprises a diffusing spacer fabric 22 provided adjacent to the outer fabric 12. Here, the diffusing spacer fabric 22 is attached to the inside of the outer fabric 12, as can be seen in FIG. 2, whereas the flexible display 14 in turn is attached to the diffusing spacer fabric 22. The diffusing spacer fabric 22 is preferably laminated to the outer fabric 12. Alternatively, it could be stitched, zipped, or hooked to the outer fabric 12, for instance. The diffusing spacer fabric 22 acts as a second separate diffusing element, and tuning the characteristics of the two diffusing elements 20, 22, such as material, thickness, shape, density, etc., allows for optimization of the overall light diffusing characteristics. The diffusing spacer fabric 22, as well as the diffusing element 20, can for example consist of woven fabric, knitted fabric, foam, non-woven material like needle padding or fiber fill, or the like. The total thickness of the diffusing element 20 and the diffusing spacer fabric 22 should chosen in relation to the lateral distances between the light sources 18. Optionally, the thickness of the diffusing element 20 decreases gradually towards the edges of the flexible substrate 16, so that the contours of the flexible display 14 are less likely to be visible.

In FIG. 1, the diffusing spacer fabric 22 has a substantially larger area compared to the flexible display 14. Namely, the area of the diffusing spacer fabric 22 essentially matches that of the front side of the shirt 10. The diffusing spacer fabric 22 having the substantially larger area compared to the flexible display 14, possibly in combination with suitable strength characteristics and/or thickness of the diffusing spacer fabric 22, prevents the contours of the flexible display 14 from being visible from the outside of garment 10.

Optionally, the flexible display 14 may additionally comprise a flexible thermo regulating layer (not shown) provided on the opposite side of the flexible substrate 16 compared to the side with the LEDs 18 for dissipating heat from the remaining display device. The thermo regulating layer may for example be made of a non-stretchable material, preferably Neoprene. The thermo-regulating layer may further be provided with holes in a repetitive pattern for guiding heat away from the display device. Except for heat management, the thermo regulating layer also offers physical strength protection against damage to the flexible display 14. A breathable fabric layer, such as GoreTex, may further be provided on the thermo regulating layer, for allowing heat to be transferred out from the flexible display 14. A reflective fabric layer may further be provided between the flexible substrate 16 and the thermo-regulating layer so that any light emitted backwards from the LEDs 18 is reflected forward.

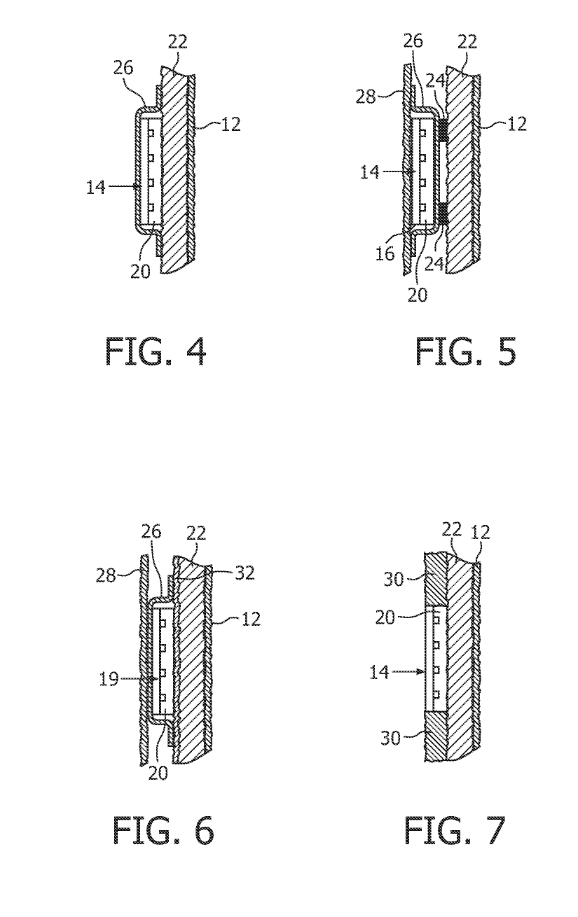

The flexible display 14 may be attached in various ways. Preferably, it is removable attached, to facilitate any repairs of the flexible display 14, to allow it to be removed when the garment 10 is to be washed, etc. The flexible display 14 can for example be attached using velcro, snap buttons, zippers, or the like, or it can be placed in a pocket arranged inside the garment 10. Such a pocket can for example be provided on a highly transparent display positioning fabric arranged between an inner fabric (which is part of the lining of the garment 10) and the diffusing spacer fabric 22. Alternatively, the flexible display 14 (with or without any pocket or pouch) can be attached to either the diffusing spacer fabric 22 or to the inner fabric. In the latter case, the flexible display 14 is preferably also attached to diffusing spacer fabric 22, in order to maintain the distance between the flexible display 14 and the diffusing spacer fabric 22, so that the display performance is not altered and/or degraded. Also, a back cover having larger area than the remaining flexible display 14 can be attached to the back of the same, to facilitate attachment (for instance by stitching) of the flexible display 14 to the textile product. FIGS. 3-6 are cross-sectional partial side views illustrating various examples of how the flexible display 14 can be attached. In FIG. 3, the flexible display 14 is attached to the diffusing spacer fabric 22 using velcro 24, in FIG. 4, the flexible display 14 is attached to the diffusing spacer fabric 22 by means of a pocket 26, in FIG. 5, the flexible display 14 is attached to an inner fabric 28 by means of a pocket 26, which in turn is attached to the diffusing spacer fabric 22 using velcro 24, and in FIG. 6, the flexible display 14 is placed in a pocket 26 which is provided on a highly transparent display positioning fabric 32 arranged between the inner fabric 28 and the diffusing spacer fabric 22. In FIG. 6, the flexible display 14 can be accessed through an opening (not shown) in the inner fabric 28.

Additional spacer fabric 30 may be provided around the flexible display 14, as illustrated in FIG. 7. That is, the additional spacer fabric 30 is placed at the same “level” as the flexible display 14, as a lateral extension of the flexible display 14. The thickness of the additional spacer fabric 30 preferably matches that of the flexible display 14, so that the part of the textile product 10 incorporating the flexible display 14 gets a uniform thickness. The additional spacer fabric 30 may optionally be formed in one piece with the diffusing spacer fabric 22.

The textile product 10 of the present invention may comprise many additional features and devices not shown in the figures. For example, it may comprise a power source for powering the display, a control unit for controlling the display, a memory for storing data related to images or animations to be displayed on the display, a communications unit for allowing wired or wireless communication with external devices, a sensor for detecting a condition and controlling the display output accordingly, audio means, etc., allowing the textile product to be used in a wide variety of applications. Also, the textile product may comprise more than one flexible display.

The person skilled in the art realizes that the present invention by no means is limited to the preferred embodiments described above. On the contrary, many modifications and variations are possible within the scope of the appended claims. For example, even though a garment is illustrated above, the textile product according to the invention may equally be a pillow, curtain, furnishing fabric, vehicle ceiling, bed textile, toy, mat or carpet, table cloth, pouch, bag, backpack, or the like.

1. A textile product (10), comprising:
an outer fabric (12), and
a flexible light-emitting display (14) arranged behind the outer fabric, which flexible display has a diffusing element (20) being arranged to receive and diffuse light emitted from the flexible display,
characterized by:
a diffusing spacer fabric (22) arranged adjacent to the outer fabric so as to receive and further diffuse light emitted from the flexible display, which diffusing spacer fabric (22) is separate from the diffusing element (20).

2. A textile product according to claim 1, wherein the diffusing spacer fabric is arranged between the flexible display and the outer fabric.

3. A textile product according to claim 1, wherein the diffusing spacer fabric has a substantially larger area compared to the flexible display.

4. A textile product according to claim 1, wherein the diffusing spacer fabric has a greater thickness than the outer fabric.

5. A textile product according to claim 1, further comprising additional spacer fabric (30) arranged around the flexible display.

6. A textile product according to claim 1, wherein the flexible display is arranged between the diffusing spacer fabric/outer fabric and an inner fabric (28).

7. A textile product according to claim 6, wherein the flexible display is attached to both the diffusing spacer fabric/outer fabric and the inner fabric.

8. A textile product according to claim 1, wherein the flexible display comprises a flexible substrate (16) having at least one light source (18) mounted thereon, and wherein a flexible thermo regulating layer is provided on the opposite side of the substrate compared to the side with the at least one light source for dissipating heat from the remaining display device.

9. A textile product according to claim 1, wherein the textile product is a garment.

10. A method for the manufacturing of a textile product (10) comprising an outer fabric (12), the method comprising:
arranging a flexible light-emitting display (14) behind the outer fabric, which flexible display has a diffusing element (20) being arranged to receive and diffuse light emitted from the flexible display,
characterized by:
arranging a separate diffusing spacer fabric (20) adjacent to the outer fabric so as to receive and further diffuse light emitted from the flexible display.

11. A flexible light-emitting display (14) adapted for use behind an outer fabric (12) in a textile product (10), which flexible display has a diffusing element (20) being arranged to receive and diffuse light emitted from the flexible display, and which textile product further comprises a separate diffusing spacer fabric (22) arranged adjacent to the outer fabric so as to receive and further diffuse light emitted from the flexible display.
